(19) United States
(12) Patent Application Publication
(10) Pub. No.: US 2018/0335149 A1
(43) Pub. Date: Nov. 22, 2018

(54) Bidirectional Control One Piece Disc-Stem

(71) Applicant: Bray International, Inc., Houston, TX (US)

(72) Inventors: Serge Trudel, The Woodlands, TX (US); Brindesh Dhruva, Katy, TX (US); Bryan Kihlken, Tomball, TX (US); Patrick O'Connell, Houston, TX (US)

(21) Appl. No.: 15/982,288

(22) Filed: May 17, 2018

Related U.S. Application Data
(60) Provisional application No. 62/507,608, filed on May 17, 2017.

(51) Int. Cl. F16K 1/226

(52) U.S. Cl. CPC F16K 1/2268; F16K 1/2265

(57) ABSTRACT

The disclosure relates to a unitary disc-stem apparatus for a valve, which has a disc defining a circumference around the disc; a first hub integral to the disc; a second hub integral to the disc; a first stem portion joining the disc at the first hub and a second stem portion joining to the disc at the second hub; a curved extended edge which is transposed on opposite sides of the disc, wherein the curved extended edge is progressively longer moving circumferentially away from the first hub and the second hub along the circumference of the disc, and longest at a position where the opposite curved extended edges of the disc are along an axis perpendicular to the first stem portion and the second stem portion.

### REFERENCE TO A “SEQUENCE LISTING”, A TABLE, OR A COMPUTER PROGRAM

Not Applicable.

### BACKGROUND

### Technical Field

The disclosure relates to improvements for valve discs, stems, and assemblies, and in particular resilient butterfly valve and valve assemblies.

There is a need for butterfly valve disc-stem assemblies utilizing a disc-stem having no cavities, pins, or fasteners, and which feature improved control and flow characteristics.

### BRIEF SUMMARY OF THE EMBODIMENTS

The disclosure relates to a unitary disc-stem apparatus for a valve, which has a disc defining a circumference around the disc; a first hub integral to the disc; a second hub integral to the disc; a first stem portion joining the disc at the first hub and a second stem portion joining to the disc at the second hub; a curved extended edge which is transposed on opposite sides of the disc, wherein the curved extended edge is progressively longer moving circumferentially away from the first hub and the second hub along the circumference of the disc, and longest at a position where the opposite curved extended edges of the disc are along an axis perpendicular to the first stem portion and the second stem portion.

The disclosure further relates to the unitary or one piece disc/stem designed to have no cavities, pins or fasteners of any kind like typical two piece butterfly valve discs with a shaft running through the disc. The design allows for control bi-directionally—or as the fluid media flows in either directions. In addition, the design-feature allows for control and optimization of required torque while positioning the disc-stem for seating and unseating.

As used herein, the terms “rotational,” “rotating,” “rotatably”, or the like in regards to movement or motion shall refer to movement around or about an axis, as defined by the valve stem of the valve system.

### BRIEF DESCRIPTION OF THE SEVERAL VIEWS OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a perspective view of an exemplary embodiment of a one piece valve disc-stem assembly.

FIG. 2 depicts a perspective view of an exemplary embodiment of a one piece valve disc-stem.

FIG. 3 depicts a top cross section view taken from line 3-3 of FIG. 2 of an exemplary embodiment of a one piece valve disc-stem.

FIG. 4 depicts a top cross section view taken from line 4-4 of FIG. 2 of an exemplary embodiment of a one piece valve disc-stem.

FIG. 5 depicts a top cross section view taken from line 5-5 of FIG. 2 of an exemplary embodiment of a one piece valve disc-stem.

FIG. 6 depicts a top cross section view taken from line 6-6 of FIG. 2 of an exemplary embodiment of a one piece valve disc-stem.

FIG. 7 depicts a front or rear view of an exemplary embodiment of a one piece disc-stem.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

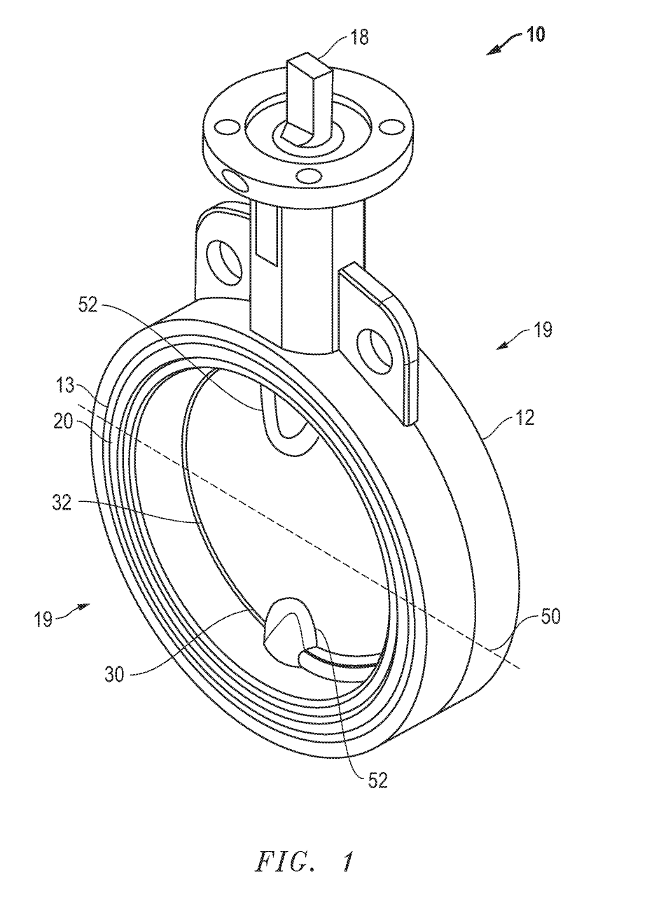

FIG. 1 depicts a perspective view of an exemplary embodiment of a valve assembly 10. The valve assembly 10, as assembled, includes a valve body 12, a disc, and a stem 18 installed into the valve body 12. The disc 32 is preferably singular, one piece, or unitary with the stem 18 forming a unitary disc-stem 30. A valve seat 20 is installed or mounted onto the valve body 12. The valve body 12 may have a substantially cylindrical shape and the inner surface 13 of the valve body 12 may define a through bore or bidirectional (or bi-directional) flow path 19.

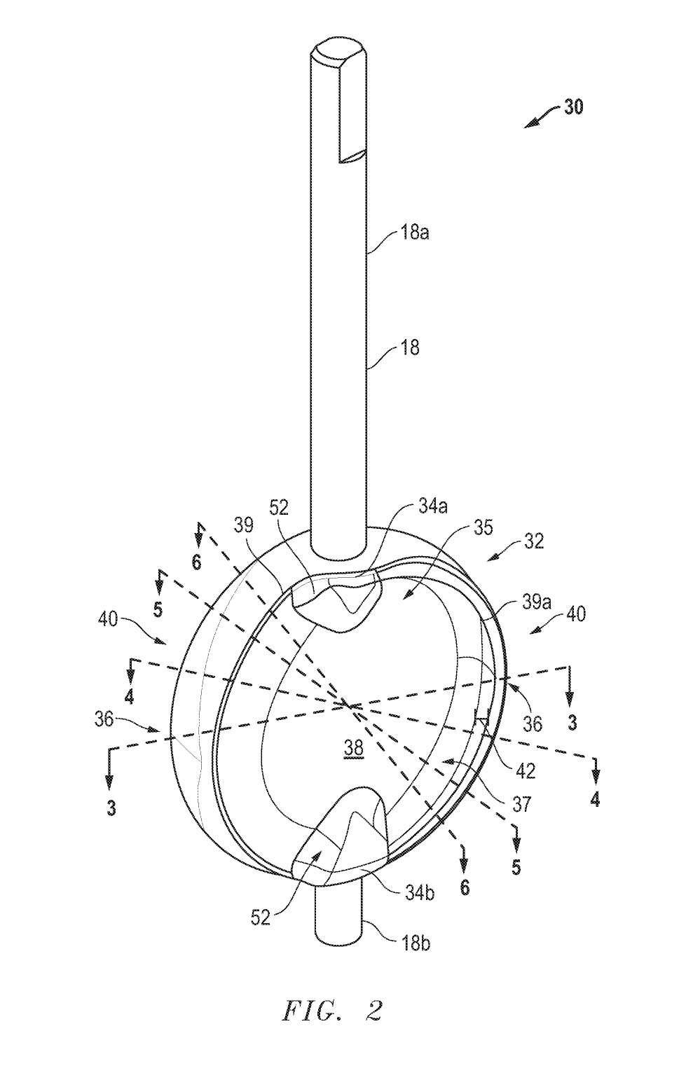

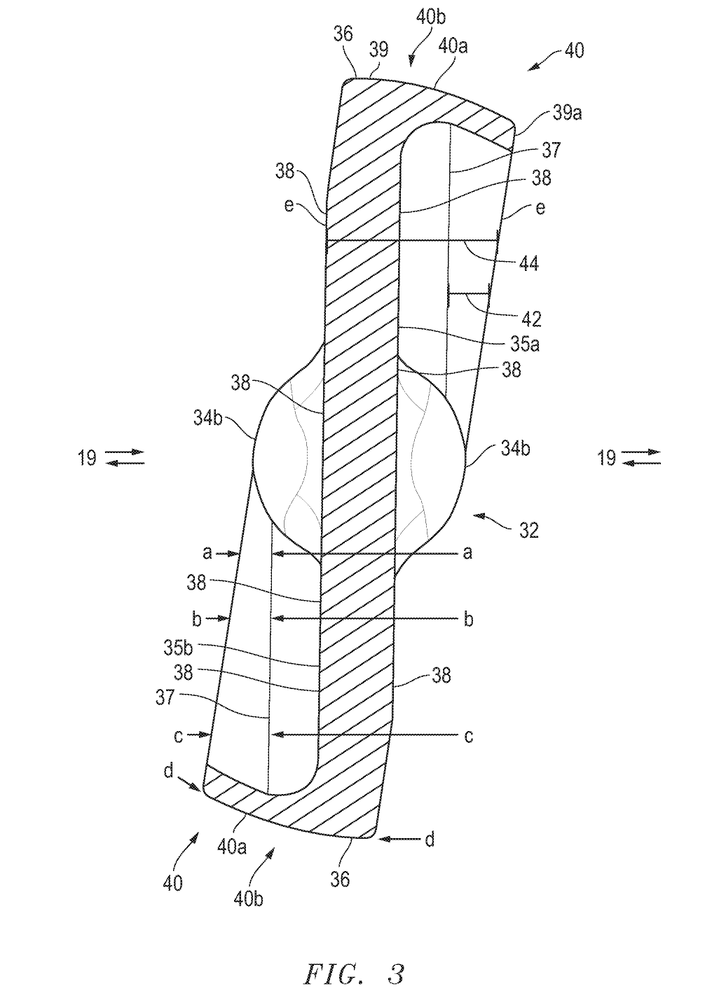

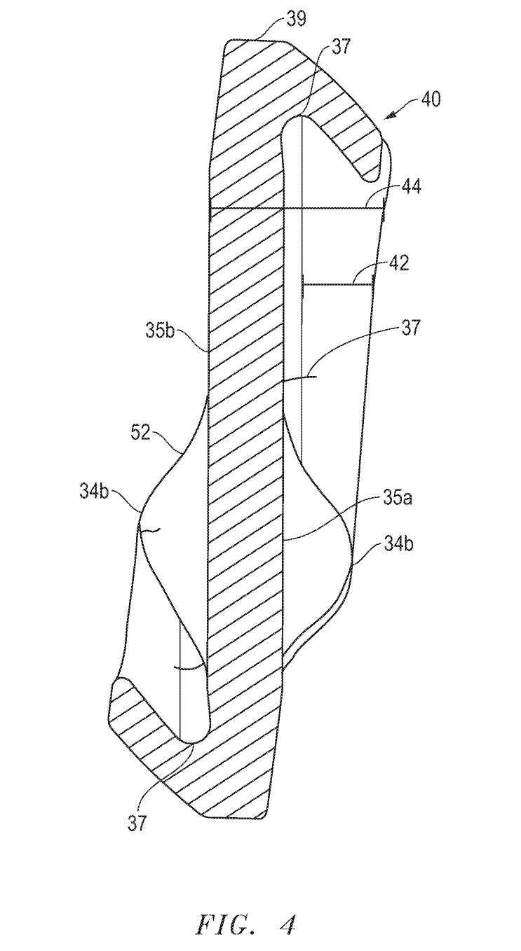

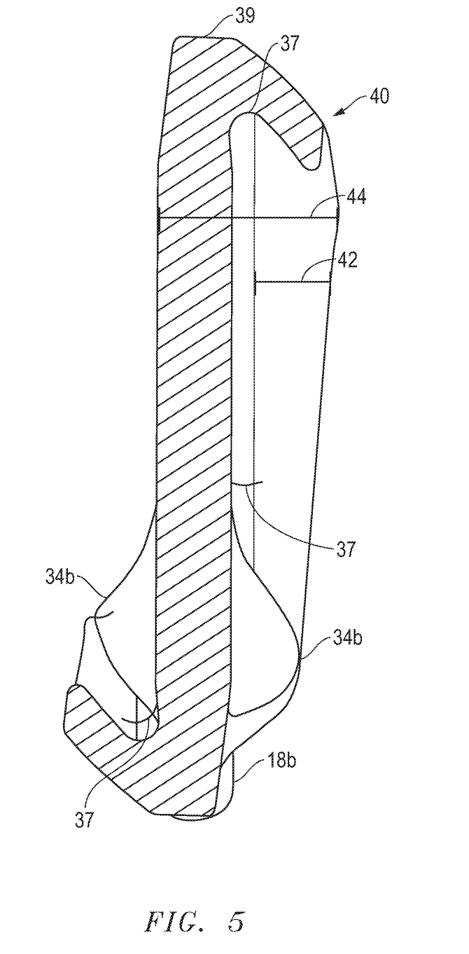

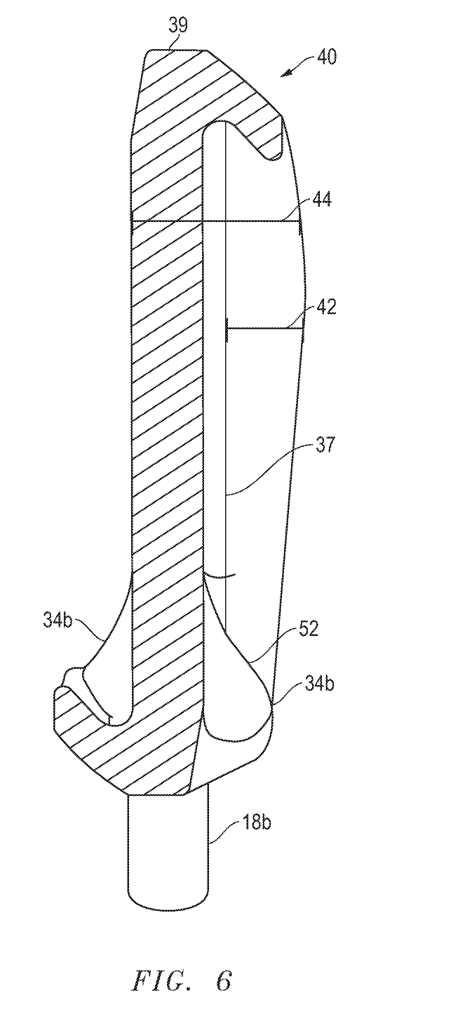

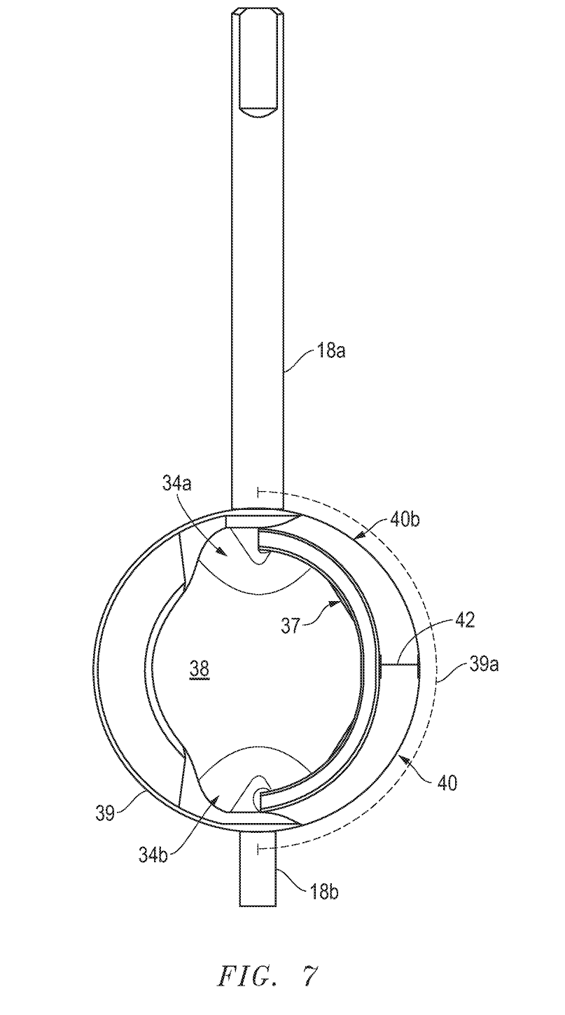

FIG. 2 depicts a perspective view of an exemplary embodiment of a unitary disc-stem 30 having a disc circumference 39. There is a shaft or stem 18 extending from the unitary disc-stem 30. The shaft or stem 18 is concentric with the unitary disc-stem 30, and the unitary disc-stem 30 is concentric when mounted in the valve body 12. The unitary disc-stem 30 has two hubs, a first hub 34a and a second hub 34b, from which respective upper stem portion 18a and lower stem portion 18b extend. Upper stem portion 18a is generally longer relative to lower stem portion 18b. The hubs 34a and 34b may be molded or joined to the disc 32 smoothly (i.e. such that there are no cavities, pins, fasteners, sharp joints or corners or edges) and may each project, extend or protrude smoothly from a first disc surface or face 35a and a second disc surface or face 35b. For example, refer FIGS. 1-2 and 4-6, specifically to the curved surfaces 52 that join, connect or transition to the hubs 34a, 34b to the disc 32. The valve disc 32 may have an extended edge or ears 40 at the rim of the disc 32 that may be elliptically cast 40a or spherically cast 40b (i.e. a shaped rounded taper preferably for purposes of characterizing flow). The disc 32 may have two disc surfaces or faces 35, a first disc surface 35a and a second disc surface 35b, on the opposite sides or surfaces of the disc 32. Each disc surface 35a, 35b include a curved or concave surface area 37 which is adjacent or unitary with/from (or terminates at) a substantially planar or flat opposite disc surface 38. The extended edge 40 is transposed on opposite sides of the disc 30, along a partial length or distance 39a of the disc circumference 39. In certain exemplary embodiments, the partial length or distance 39a of which the extended edge 40 extends or protrudes from the disc 35 is about half the length/distance of the circumference 39, as defined from the first hub 34a to the second hub 34b (see FIG. 7). The extended edge 40 is progressively longer from the hubs 34a and 34b where the disc 32 transitions into the outer edges 36 of the disc 32 (for variable length 42 see FIG. 3 wedge-like region represented or defined between lines a-a, b-b and c-c; except that the true length 44 of extended edge 40 at each interstitial position around disc 32 is defined from one end of these lines to the opposite flat disc face 38 for example see line e-e). Further, the curved extended edge 40 may be longest at a position where the opposite outer edges 40 of the disc are along an axis perpendicular 50 to the upper stem portion 18a and the lower stem portion 18b (see FIG. 1 regarding the axis 50 perpendicular to the stem portions 18a, 18b). The extended edge 40 may extend or protrude from the partially concave portion or surface 37 of the first disc face 35a. On the second disc face 35b, the extended edge 40 may be transposed (see FIG. 3) onto the opposite side of the disc 30. Likewise, the partially concave or surface portion 37 of the second disc face 35b may also be transposed on the opposite side of the disc 30 (i.e. 180 degrees around the rim of the disc 32). The longest portion of the extended edge or ears 40 is perpendicular to the shaft at the outer edges 36 of the disc 32 at line d-d (as seen in cross-section in FIG. 3). As shown in FIG. 3-6, the variable length 42 and the true length 44 of edge 40 may decrease as the cross sectional view is angled closer or at a smaller axis/angle of viewing to the hubs 34a, 34b. In particular, when viewing the FIG. 3-6 sequentially, (i.e. from FIG. 3 then to FIG. 4 then to FIG. 5 and then FIG. 6), the edge 40 may get progressively shorter in length. Line 4-4 of FIG. 2 is at a seventy degree (70°) viewing angle (relative to the axis of the stems 18a, 18b). Line 5-5 of FIG. 2 is at a fifty degree (50°) viewing angle (relative to the axis of the stems 18a, 18b). Line 6-6 of FIG. 2 is at a thirty degree (30°) viewing angle (relative to the axis of the stems 18a, 18b). Accordingly, FIG. 4 may show a greater variable length 42 and true length 44 than the variable length 42 and true length 44, respectively, as depicted in FIG. 6. When the unitary disc-stem 30 is installed in a conventional resilient elastomeric seated butterfly valve, there is an increase in rangeability of that valve and extensions in its ability to absorb excess energy results. The extended edge or ears 40 generally surrounds the disc 32 at its rim or circumference 39 although it may terminate for a short distance only at the hubs 34a, b. The term “ears” 40 is used herein in the context of being rounded or curled at the rim, concave on one side, and flatter on the side opposite juxtaposed from the concave side. The term “transposed” is used in the context of the concave or surface portion 37. The partially concave portion or surface 37 is juxtaposed from its backside or substantially planar or flat opposite disc surface 38. The partially concave portion or surface 37 and its juxtaposed backside substantially planar or flat opposite disc surface 38 are reversed or inverted along each half of the disc 32, wherein such halves are defined by the axis as defined by the valve stem 18.

FIG. 7 depicts a front or rear view of an exemplary embodiment of a one piece disc-stem 30. The front and rear view of the exemplary embodiment of the one piece or unitary disc-stem 30 are identical, because in certain exemplary embodiments, said disc-stem 30 may be symmetrical. In FIG. 7, the ears or edges 40 are spherically cast 40b and may cover the concave surface 37 of the disc face 35. The substantially flat surface 38 is adjacent to the concave surface 37. Further, the edge 40 is shown along a partial distance 39a of the circumference 39 and has a variable length 42, wherein the variable length 42 (and the true length 44) is greatest at an axis perpendicular to the stem portions 18a, 18b.

The design of this unitary disc-stem 30 may be completely symmetrical. Fluid can travel through the flow path 19 in both directions. The unitary disc-stem 30 allows a bi-directional control valve with the same control characteristic and flow curve when fluid travels in a pipe in either direction around this disc/stem.

The variable length of the disc extended edge 40 (for variable length see wedge-like region represented or defined between lines a-a, b-b and c-c; except that the true length 44 of extended edge 40 at each interstitial position around disc 32 is defined from one end of these lines to the opposite flat disc face 38 for example see line e-e) provides a variable area where during the stroke of the disc 32 from closed to open, the variable area between the disc edge 40 and the valve body seat 20 is extended where the area is largest at the disc edge 40 perpendicular to the stem 18 at the outer edges of the disc 36, which creates a longer and straightening path for the fluid. This accelerates the fluid more gradually, creating a Venturi effect variable through the circumference of the disc edge 40, and spreading the flow and velocity more evenly around the disc opening (defined between the disc edge 40 and the seat 20 and variable depending upon the rotational position of the disc 32 relative to the seat 20) and further increasing rangeability.

Controlling the pressure drop and fluid velocity only at the edge of the disc 40 is very important since any other shape on the disc 32 makes the control characteristic less than ideal. Therefore, the need to use a flat or planar disc face 38 without a hump where you would typically see a shaft running through the valve disc, bolts, or offset shafts from the sealing edge is very important. This assures that the flow characteristic of the disc 32 is controlled at the disc edge 40 and can be shaped for any control characteristic from equal percentage, linear or any other characteristic required.

The disc edge 40 can be spherically shaped 40B and the sphere center offset from the center of the disc so a portion of the edge 40 is always in contact with the seat 20 and the edge 40 can be shaped to include a characterized shape.

The disc edge 40 can be shaped and positioned to minimize seat 20-disc 32 interference while achieving zero flow at spherically machined disc edge 36 which is concentric to the disc stem shaft throughout the lifecycle of the valve 10. This assures low-torque requirements throughout the valve's life.

FIG. 3 depicts a top cross section view of an exemplary embodiment of a one piece valve disc 30. The cross section depicted is at the longest portion of the extended edges 40, which is an axis perpendicular (i.e. along axis 50) to the shaft or stem 18 at the outer edges of the disc 36.

The unitary disc-stem 30 may be designed to have no cavities, pins or fasteners of any kind. This design without fasteners is suited for use in pharmaceutical, food or any sanitary service where a smooth valve control element is essential in creating a final control element with the best control characteristics without the typical high acceleration through a conventional butterfly valve disc, resulting in high velocity on the disc edge and subsequent disturbance of the fluid and cavitation. This is important in certain processes where control is important and higher than acceptable pressure drop exists for a typical butterfly valve and where that process physical state cannot be altered through the valve 10 through better control at the initial angle of opening through most of its travel. The design allows for this type of control bi-directionally—or as the fluid media flows in either directions. In addition, the design-feature allows for control and optimization of required torque while positioning the disc/stem for seating and unseating.

While the embodiments are described with reference to various implementations and exploitations, it will be understood that these embodiments are illustrative and that the scope of the inventive subject matter is not limited to them. Many variations, modifications, additions and improvements are possible. For example, the techniques used herein may be applied to any valve system or assembly used for piping systems. Additionally, the valve assembly 10 may be used on any size of valve and, moreover, the figures included within this disclosure depict merely some exemplary embodiments. By way of example, the valve body 12 may be of a wafer style, lug style or double flanged style. On double flanged style valves, the width of the body 12 may be much larger than wafer and lug style valves that have the same width; this may mean the seat 40 may be adjusted or “stretched”, however the performance and features mentioned in this disclosure will be the same.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A unitary disc-stem apparatus for a valve, comprising:
a disc defining a circumference around the disc;
a first hub integral to the disc;
a second hub integral to the disc;
a first stem portion joining the disc at the first hub and a second stem portion joining to the disc at the second hub;
a curved extended edge which is transposed on opposite sides of the disc, wherein the curved extended edge is progressively longer moving circumferentially away from the first hub and the second hub along the circumference of the disc, and longest at a position where the opposite curved extended edges of the disc are along an axis perpendicular to the first stem portion and the second stem portion.

2. The unitary disc-stem apparatus according to claim 1, wherein the disc is a substantially flat disc face between the first hub and the second hub.

3. The unitary disc-stem apparatus according to claim 1, wherein the disc is completely symmetrical.

4. The unitary disc-stem apparatus according to claim 1, wherein the curved extended edge is elliptical.

5. The unitary disc-stem apparatus according to claim 1, wherein the curved extended edge is spherical.

6. The unitary disc-stem apparatus according to claim 5, wherein the spherically cast extended edge has a sphere center positioned so that a portion of the spherically cast extended edge is always in contact with a seat of the valve and the spherically cast extended edge is shaped to include a characterized shape.

7. The unitary disc-stem apparatus according to claim 1, further comprising:
a body having a substantially cylindrical shape defining a body inner surface; and
a seat mounted to the body.

8. The unitary disc-stem apparatus according to claim 7, wherein the disc provides sealing from the body.

9. The valve assembly apparatus according to claim 7, wherein fluid can travel around the disc through the valve body in both directions.

10. A valve assembly apparatus for a flow of fluid, comprising:
a disc defining a circumference and having a first disc surface and a second disc surface opposite the first disc surface;
an upper stem of the disc, wherein the upper stem is joined with the disc;
a lower stem of the disc, wherein the lower stem is joined with the disc, and wherein the upper stem is longer than the lower stem;
a first extended edge protruding a first edge length from the first disc surface along a partial distance of the circumference;
a second extended edge protruding a second edge length from the second disc surface along a second partial distance of the circumference, wherein the second extended edge is transposed from the first extended edge across an axis defined by the upper stem and lower stem; and wherein the first partial distance and the second partial distance are equivalent; and
wherein the first edge length and the second edge length are of variable length.

11. The apparatus according to claim 10, further comprising an upper hub unitary to the disc and a lower hub unitary to the disc, wherein the upper stem is unitary to the upper hub, and wherein the lower stem is unitary to the lower hub.

12. The apparatus according to claim 11, wherein the first disc surface and the second disc surface each comprise a flat disc face, wherein each of the flat disc faces is between the upper hub and the lower hub.

13. The apparatus according to claim 12, wherein the first disc surface and the second disc surface each further comprise a concave surface between each of the flat disc faces and the first and second extended edge, respectively.

14. The apparatus according to claim 13, wherein the first edge length and the second edge length are greatest at an axis perpendicular to the upper stem and the lower stem.

15. A method for controlling a fluid flow, comprising the steps of:
traveling the fluid flow around a symmetrical disc in a first direction and in a second direction, wherein a control characteristic of the fluid flow in the first direction is the same when the fluid flow is in the second direction;
and further wherein a flow curve of the fluid flow in the first direction is the same when the fluid flow is in the second direction; and
stroking the symmetrical disc from a closed position to an open position using a variable length of an edge extended from the symmetrical disc, wherein the variable length is extended greatest at an axis perpendicular to a stem of the symmetrical disc.

16. The method according to claim 15, further comprising the step of controlling and characterizing the fluid flow at the edge of the symmetrical disc, while minimizing flow interference at a flat disc face of the symmetrical disc.

17. The method according to claim 16, further comprising the step of controlling a pressure drop at the edge of the symmetrical disc.

18. The method according to claim 17, further comprising the step of characterizing the fluid flow at two hubs for two stem portions by always contacting a curved hub surface with a seat mounted in a valve, wherein the curved hub surface has a characterized profile.
